(19) United States
(12) Patent Application Publication
(10) Pub. No.: US 2001/0037883 A1
(43) Pub. Date: Nov. 8, 2001

(54) MONITORING CHARACTERISTICS OF A WELL FLUID FLOW

(76) Inventors: ANTHONY F. VENERUSO, MISSOURI CITY, TX (US); GERALD W. ROBERTSON, MISSOURI CITY, TX (US)

Correspondence Address: PATENT COUNSEL SCHLUMBERGER, TECHNOLOGY CORPORATION, 14910 AIRLINE ROAD, PO BOX 1590, ROSHARON, TX, 775831590

(21) Appl. No.: 09/193,987

(22) Filed: Nov. 18, 1998

(51) Int. Cl. G01N 29/02; G01N 37/00

(52) U.S. Cl. 166/250.01; 73/61.75

(57) ABSTRACT

An apparatus for use in a subterranean well includes a valve, a transducer and a circuit. The valve is adapted to propagate acoustic energy in response to a well fluid flow contacting the valve. The transducer is acoustically coupled to the valve and isolated from the flow to furnish an indication of the acoustic energy. The circuit is adapted to furnish signals to transmit stimuli indicative of the characteristic to a surface of the well based on the indication furnished by the transducer.

### BACKGROUND

The invention relates to monitoring characteristics of a well fluid flow.

Oil and gas production typically involves directing well fluid flows from different production zones to a surface of the well. The well fluid flow from a particular production zone may include a mixture of substances, such as particulates (sand particles, for example), gas and oil. An operator at the surface of the well may need to know these and possibly other characteristics of the flow from a particular production zone so that the operator may regulate a downhole valve to control the flow. Without this knowledge, the operator may restrict the flow more than necessary to create a large safety margin to prevent damage to the production system. Unfortunately, due to this type of control, production from the well may be unduly limited.

As an example of a characteristic of the well fluid flow, the flow may include particulates, such as sand particles, that may erode and fill downhole equipment, such as production valves, sensors and tubing, as just a few examples. This damage, in turn, may be extremely costly in terms of lost production, unreliable operation, short equipment lifetime and risk of complete, sudden failure of the production system. By knowing the amount of sand in the flow, the operator may regulate a valve from that zone, a technique that may include, as an example, shutting off production from the zone if the amount of sand flow surpasses a predetermined threshold.

As another example of a characteristic of the well fluid flow, the flow may include escaping gas bubbles. In this manner, if the pressure at the sand face is not greater than the production zone's bubble point (i.e., the point at which dissolved gas begins to leave the well fluid), then bubbles of gas develop in the flow. The bubbles may cause, as examples, lost production due to an apparent skin effect as well as actual formation damage, plugging of the perforations with paraffin solids build-up and erosion of production equipment. By knowing the amount of bubbles present in the flow, the operator may regulate a valve accordingly to control the pressure. For example, if the amount of bubbles in the flow surpasses a predetermined threshold, the operator may restrict flow through the valve to increase pressure at the sand face and decrease the amount of bubbles. Conversely, if the bubble flow is relatively small or non-existent, the operator may further open the valve to increase the production in the zone.

One way to determine the amount of sand in the flow is to lower a conventional sand detection tool 4 (schematically depicted in FIG. 1) downhole. The tool 4 may include a metallic (steel, for example) probe 6 that is positioned inside a conduit 5 (of the tool 4) to intrude into a well fluid flow 8. In this manner, particulates in the flow 8 impinge against the probe 6 and cause a piezoelectric sensor (not shown) inside the probe 6 to generate a resultant electrical signal. When sand impinges against the probe 6, the resulting electrical signal has a frequency signature that electrically identifies the sand particles. An amplifier 10 of the tool 4 may amplify the electrical signal, and a bandpass filter 12 may filter frequencies outside of those in the signature from the signal. A discriminator 14 may be used to reject electrical signals having low magnitudes, such as noisy signals, for example. When sand impinges against the probe 6, the resulting output signal that is provided by the discriminator 14 may resemble an approximate pulse that a pulse shaper 16 forms into a substantially square pulse and uses to clock a counter 18. As a result of this arrangement, the counter 18 typically indicates a rate of sand flow that is present in the flow 8.

Because the probe 6 intrudes into the flow 8, the probe 6 may interfere with the flow 8, prevent other tools from being run downhole and limit the lifetime of the tool 4. More particularly, the lifetime of the probe 6 may be short because of the abrasion caused by impinging particulates (such as the sand particles), and the seals and connectors that are used to connect the probe 6 to the electrical components described above may introduce reliability problems for the tool 4.

Thus, there is a continuing need for a system to address one or more of the difficulties stated above.

### SUMMARY

In one embodiment of the invention, an apparatus for use in a subterranean well includes a valve, a transducer and a circuit. The valve is adapted to propagate acoustic energy in response to a well fluid flow contacting the valve. The transducer is acoustically coupled to the valve and isolated from the flow to furnish an indication of the acoustic energy. The circuit is adapted to furnish signals to transmit stimuli indicative of the characteristic to a surface of the well based on the indication furnished by the transducer.

In another embodiment, a method for use in a subterranean well includes detecting acoustic energy caused by a well fluid flow contacting a downhole production valve. A characteristic of the flow is determined based on the detected acoustic energy.

Other embodiments of the invention will become apparent from the following description, from the drawing and from the claims.

### BRIEF DESCRIPTION OF THE DRAWING

FIG. 1 is a schematic diagram of a sand detection tool of the prior art.

FIG. 2 is a cross-sectional view of a production valve according to an embodiment of the invention.

FIG. 3 is a schematic diagram of a sensor circuit according to an embodiment of the invention.

FIG. 4 is a spectral energy versus frequency plot of acoustic energy caused by a well fluid flow.

FIG. 5 is a flow diagram illustrating an algorithm that is executed by a processor of FIG. 3 according to an embodiment of the invention.

FIGS. 6 and 7 are schematic views illustrating different mounting arrangements for a transducer of the sensor circuit of FIG. 3.

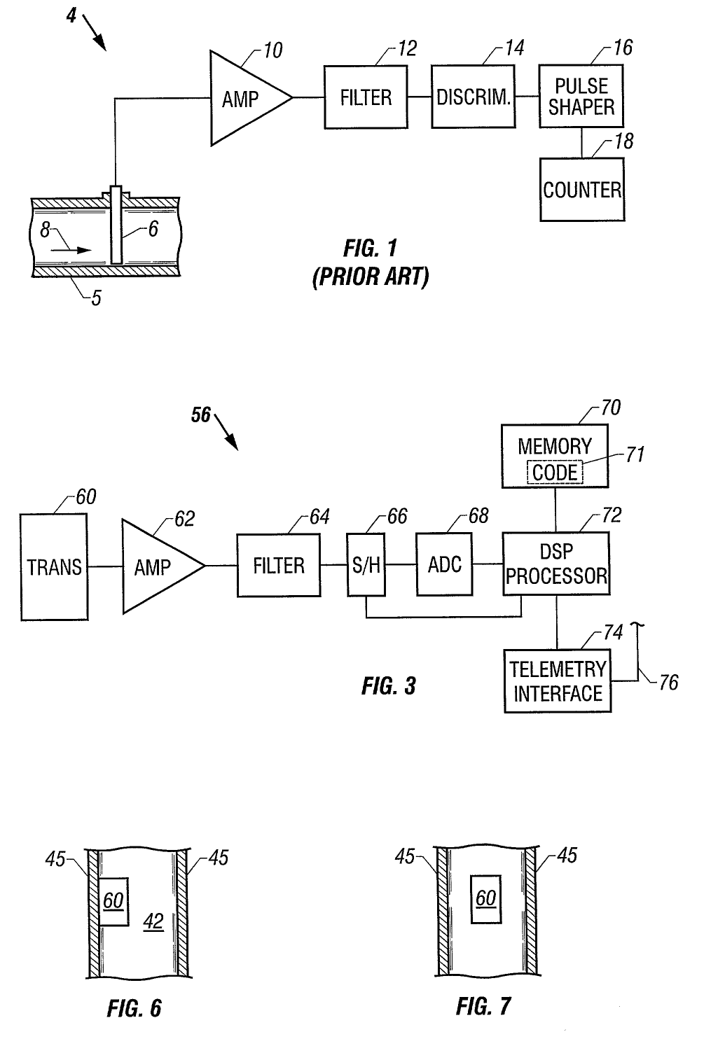

### DETAILED DESCRIPTION

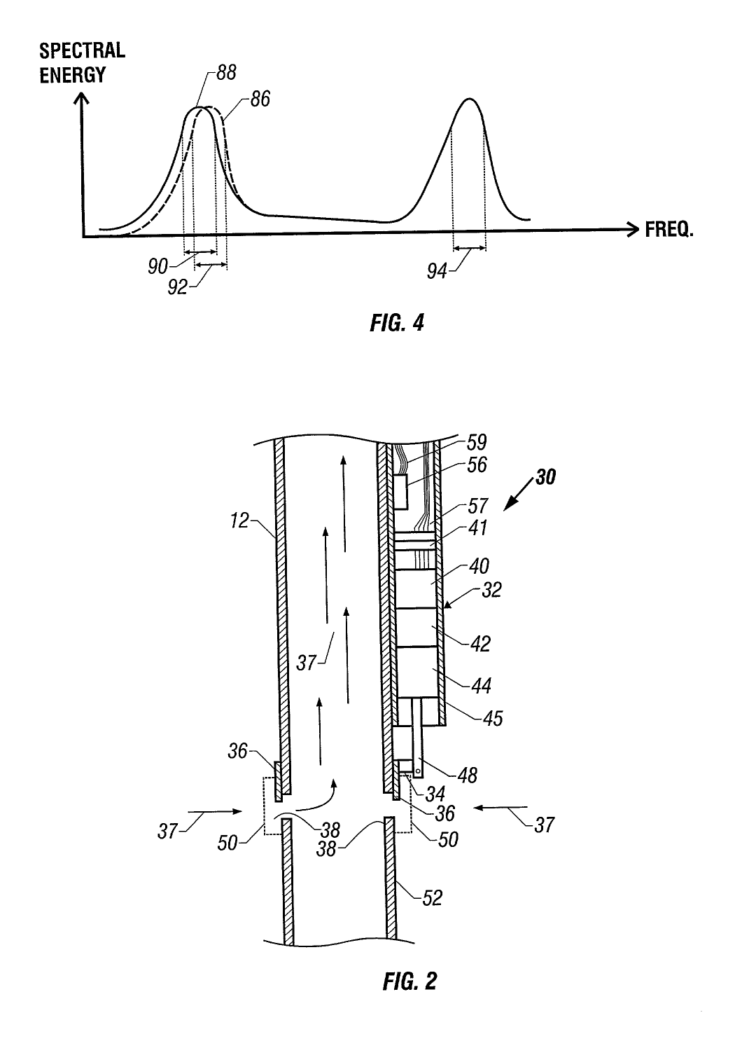

Referring to FIG. 2, an embodiment of a production valve 30 in accordance with the invention may be formed from a linear actuator 32 and a valve cover, or sleeve 36. The sleeve 36 is coaxial with and closely circumscribes a production tubing 52, and due to this arrangement, the linear actuator 32 may cause the sleeve 36 to slide in either direction along the production tubing 52 to control a rate of a well fluid flow 37 through radial ports 38 of the production tubing 52. More particularly, in some embodiments, the linear actuator 32 has a shaft 48 that is coupled (via an elbow 34, for example) to the sleeve 36. In this manner, the linear actuator 32 may extend or retract the shaft 48 to move the sleeve 36 to selectively change the rate of the flow 37. One or more seals (O-rings, for example) may seal the shaft 48 to a generally cylindrical housing 45.

In some embodiments, the linear actuator 32 may include a motor 40 that transfers torque via a gear box 42 to a linear actuator drive, such as a ball screw drive 44, to move the shaft 48 either in or out of the linear actuator 32. The motor 40, the gear box 42 and the ball screw drive 44 may all be located inside the housing 45 that is mounted to and generally extends along the outside of the production tubing 52. Power lines 57 for proving power to the actuator 32 and motor 40 may extend through a bulkhead 41 of the valve 30.

For purposes of determining characteristics (a volumetric rate of sand flow and a volumetric rate of bubble flow, as examples) of the flow 37, the valve 30 may include a sensor circuit 56 that is located inside a sealed chamber 57 of the valve 30. In this manner, the sensor circuit 56 is isolated from the flow 37 and from well fluid that may surround the housing 45. Conventional detection systems (a sand detection system, for example) may include a probe that extends into the flow 37. However, unlike these systems, the sensor circuit 56, in some embodiments, may form a complete package for detecting characteristics of the flow 37 and does not require intrusion into the flow 37.

To accomplish the above-described features, the sensor circuit 36 may monitor one or more characteristics of the flow 37 by analyzing acoustic energy that propagates through the housing 45. The acoustic energy, in turn, is attributable to the flow 37 contacting the valve 30. For example, the flow 37 may generally contact an area 50 that surrounds the ports 38. Due to this contact, particulates (sand particles, for example) and bubbles may impinge against components of the valve 30, such as the sleeve 36 and the tubing 52, and as a result, create the acoustic energy that propagates through the housing 45.

The sensor circuit 56 takes advantage of the propagation of acoustic energy through the housing 45 by being acoustically coupled to the housing 45 to detect one or more characteristics of the flow 37. Once the sensor circuit 56 detects the characteristic(s), the sensor circuit 56 may transmit (via wires 59 or other telemetry arrangements, for example) indication(s) of the characteristic(s) to a surface of the well, as described below.

Among the characteristics detected by the sensor circuit 56 may be a volumetric rate of sand flow and a volumetric rate of bubble flow, as examples.

Thus, the advantages of the above-described arrangement may include one or more of the following: characteristics of a well fluid flow may be detected without disrupting the flow; an intrusive probe is not required; the lifetime of the sensor circuit may be longer than conventional sensing arrangements; seals and connectors for a detection probe are not required; detection accuracy may be enhanced; and the sensor circuit may be mounted downhole for monitoring the flow for the lifetime of the production system. Other advantages may become apparent from the following description, from the drawing and from the claims.

Referring to FIG. 3, more particularly, the sensor circuit 56 may include a transducer 60 that is acoustically coupled to the housing 45 to convert the acoustic energy (that propagates through the housing 45) into an electrical signal that indicates the energy. As examples, the transducer 60 may be directly mounted to the housing 45, as depicted in FIG. 6, or the transducer 60 may not be directly secured to the housing 45, as depicted in FIG. 7. The transducer 60 may or may not be located in an atmospheric chamber.

In some embodiments, the sensor circuit 56 transforms the electrical signal that is furnished by the transducer 60 into the frequency domain for purposes of identifying characteristics of the flow 37, as described below. To accomplish this, in some embodiments, the electrical signal from the transducer 60 is received by an amplifier 62 that amplifies the electrical signal to furnish a resultant amplified signal. This amplified signal is received by an anti-aliasing filter 64 that may be used to limit the frequency bandwidth of the amplified signal for purposes of sampling. The sampling may be performed by a sample and hold (S/H) circuit 66, and the resultant sampled analog voltage may be furnished by the circuit 66 to an analog-to-digital converter (ADC) 68.

The ADC 68 provides digital values (indicative of the signal furnished by the circuit 66) that are received by a discrete signal processing (DSP) processor 72 (a microprocessor, for example). The DSP processor 72, in turn, may perform a frequency transform (a Fast Fourier Transform (FFT), as an example) of the digital values to form a frequency domain representation of the acoustic energy. By doing this, the DSP processor 72 may then analyze the spectral composition of the acoustic energy to find signatures that identify different characteristics of the flow 37.

For example, referring to FIG. 4, if the flow 37 includes a significant amount of sand, then a spectral plot 86 of the acoustic energy may include a band 90 of frequencies that are associated with a significant percentage of the energy. In this manner, the DSP processor 72 may detect impinging sand particles by integrating a representation (an FFT representation, for example) of the spectral plot 86 over the band 90 of frequencies to determine the energy present in the band 90. If the integrated energy surpasses a predetermined threshold (an event that indicates a significant amount of detected sand), then the DSP processor 72 may indicate detection of the sand by interacting with a telemetry interface 74 (see FIG. 3) to transmit signals via the wires 59 to the surface of the well. Similarly, the DSP processor 72 may detect impinging bubbles by integrating a representation of the spectral plot 86 over a band 94 (see FIG. 4) of frequencies that is associated with the bubbles. If the energy in the band 94 surpasses a predetermined threshold, then the DSP processor 72 may indicate detection of the bubbles by using the telemetry interface 74 to transmit signals via the wires 59 to the surface of the well.

Thus, in general, the DSP processor 72 may use the telemetry interface 74 to transmit stimuli, such as electrical signals, that indicate rates at which the bubbles and sand are impinging against the valve 30. More particularly, as an example, the DSP processor 72 may count the number of times each minute (as an example) in which the energy in the band 90 exceeds the predetermined threshold, and in this manner, the DSP processor 72 may, approximately every minute (as an example), use the telemetry interface 74 to transmit an indication of this rate to the surface of the well. As another example, in some embodiments, the DSP processor 72 does not cause the telemetry interface 74 to transmit indications of the rates uphole, but rather, the DSP processor 72 may cause the telemetry interface 74 to transmit only an indication of a warning that a particular rate (a sand flow rate, for example) has surpassed an acceptable level. In other embodiments, both the indications of the rates and the warnings may be transmitted uphole. Other arrangements are possible.

Although the sleeve 36 and tubing 52 may be coated with wear resistant materials, such as tungsten carbide and/or zirconium, these components of the valve 30 may eventually erode or generally deteriorate due to the impinging bubbles and particulates, as examples. This deterioration, in turn, may affect the spectral composition of the acoustic energy. For example, still referring to FIG. 4, the band 90 of frequencies that are initially associated with sand when the valve 30 is substantially new may gradually shift over time so that a new band 92 of frequencies is associated with sand after the valve 30 exhibits signs of wear. To accommodate for deterioration of the valve 30, the DSP processor 72 may monitor the bands of frequencies that are associated with the different characteristics to detect gradual frequency shifts and adjust for these shifts.

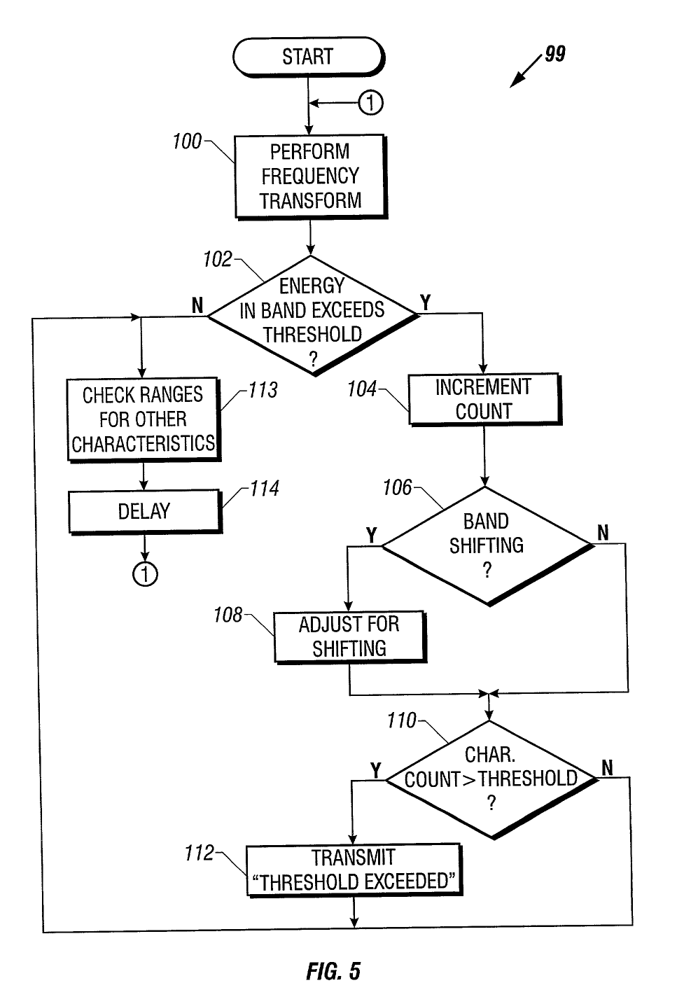

Referring to FIG. 5, in some embodiments, to detect a characteristic of the flow 37, the DSP processor 72 may perform an algorithm 99 that, as an example, may be the result of the DSP processor 72 executing program code 71 (see FIG. 3) that is stored in a memory 70 of the sensor circuit 56. In the performance of the algorithm 99, the DSP processor 72 may decompose the acoustic energy into its frequency components by performing (block 100) a frequency transform of the digital values that are provided by the ADC 68. The DSP processor 72 may perform this transformation several times every second, for example.

The transformation permits the DSP processor 72 to analyze different frequency bands, each of which is associated with a particular characteristic. In this manner, for a particular characteristic, the DSP processor 72 may determine (diamond 102) if the energy in a band of frequencies that is associated with the characteristic exceeds a predetermined threshold. To arrive at this determination, the DSP processor 72 may integrate or average the spectral components over the band. If the threshold is exceeded, the DSP processor 72 may increment (block 104) a count for the characteristic. The number of counts per unit of time (a minute, for example) may indicate a flow rate, for example. Next, the DSP processor 72 may determine (diamond 106) if the band of frequencies that is associated with the characteristic is shifting. If so, the DSP processor 72 may adjust (block 108) the boundaries of the band that the DSP processor 72 uses to detect the particular characteristic.

Next, the DSP processor 72 may determine (diamond 110) whether the counts per unit of time exceeds a predetermined threshold. For example, this occurrence may indicate that a predetermined flow rate (a sand flow rate, for example) has been exceeded. If the predetermined threshold is exceeded, the DSP processor 72 may transmit (block 112), via the telemetry interface 74, signals to the surface that indicate the detected characteristics, as described above. The DSP processor 72 may subsequently check (block 113) other bands to detect other characteristics of the flow and then may delay (block 114) for a predetermined time before performing another frequency transform and repeating the above-described process. If the DSP processor 72 determines (diamond 102) that the energy in the band that is associated with the characteristic is below the predetermined threshold, then the DSP processor 72 may check (block 113) for other characteristics of the flow, as described above.

Other embodiments are within the scope of the following claims. As examples, the valve 30 may be used in a lateral well. A production system may include several valves, and each of these valves may include the sensor circuit 56. Downhole components other than a valve, a production tubing or a sleeve may be used to generate and/or propagate the acoustic energy. Flow restriction devices (a ball valve, for example) other than a sleeve valve may be used. As another example, instead of performing frequency transformations, the sensor circuit may include bandpass filters, each of which is associated with a different characteristic. In this manner, the output signals from the bandpass filters may be monitored (by a microcontroller, for example) for purposes of detecting the characteristics. As another example, the DSP processor 72 may be replaced by discrete logic.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. An apparatus for use in a subterranean well, comprising:
a valve adapted to propagate acoustic energy in response to a well fluid flow contacting the valve;
a transducer acoustically coupled to the valve and isolated from the flow to furnish an indication of the acoustic energy; and
a circuit adapted to furnish signals to transmit stimuli indicative of the characteristic to a surface of the well based on the indication furnished by the transducer.

2. The apparatus of claim 1, wherein the circuit comprises:
a processor adapted to use the indication to analyze a spectral composition of the acoustic energy.

3. The apparatus of claim 2, wherein the circuit further comprises:
an interface to generate the signals,
wherein the processor is further adapted to cause the interface to generate the signals based on the analysis of the spectral composition.

4. The apparatus of claim 1, wherein the characteristic comprises a rate at which particulates impinge against the valve.

5. The apparatus of claim 4, wherein the stimuli indicates the rate.

6. The apparatus of claim 4, wherein the stimuli indicates when the rate exceeds a predetermined threshold.

7. The apparatus of claim 4, wherein the particulates comprise:
sand particles.

8. The apparatus of claim 1, wherein the characteristic comprises a rate at which bubbles impinge against the valve.

9. The apparatus of claim 8, wherein the stimuli indicates the rate.

10. The apparatus of claim 8, wherein the stimuli indicates when the rate exceeds a predetermined threshold.

11. A system for use in a subterranean well, comprising:
a production tubing having a port to establish communication between a passageway of the tubing and a well fluid flow, the tubing adapted to propagate acoustic energy in response to the well fluid flow contacting a portion of the tubing surrounding the port;
a transducer acoustically coupled to the tubing and isolated from the flow to furnish an indication of the acoustic energy;
a communication link adapted to establish communication with a surface of the well; and
a circuit adapted to furnish signals to the communication link indicative of the characteristic based on the indication furnished by the transducer.

12. The system of claim 11, wherein the circuit comprises:
a processor adapted to use the indication to analyze a spectral composition of the acoustic energy.

13. The system of claim 11, wherein the circuit further comprises:
an interface to generate the signals,
wherein the processor is further adapted to cause the interface to generate the signals based on the analysis of the spectral composition.

14. The system of claim 11, wherein the characteristic comprises a rate at which particulates impinge against the portion of the tubing.

15. The system of claim 14, wherein the stimuli indicates the rate.

16. The system of claim 14, wherein the stimuli indicates when the rate exceeds a predetermined threshold.

17. The system of claim 14, wherein the particulates comprise:
sand particles.

18. The system of claim 11, wherein the characteristic comprises a rate at which bubbles impinge against the portion of the tubing.

19. The system of claim 18, wherein the stimuli indicates the rate.

20. The system of claim 18, wherein the stimuli indicates when the rate exceeds a predetermined threshold.

21. A method for use in a subterranean well, comprising:
detecting acoustic energy caused by a well fluid flow contacting a downhole production valve; and
determining a characteristic of the flow based on the detected acoustic energy.

22. The method of claim 21, wherein the act of detecting comprises:
positioning a transducer downhole;
isolating the transducer from the flow; and
acoustically coupling the transducer to the production valve.

23. The method of claim 21, further comprising:
transmitting an indication of the characteristic to a surface of the well.

24. The method of claim 23, wherein the characteristic comprises a flow of particulates and the indication represents a rate of the flow of particulates.

25. The method of claim 24, wherein the particulates comprise sand particles.

26. The method of claim 23, wherein the characteristic comprises a flow of bubbles and the indication represents a rate of the flow of bubbles.
